(19) United States
(12) Patent Application Publication
(10) Pub. No.: US 2019/0143664 A1
(43) Pub. Date: May 16, 2019

(54) FLEXIBLE DISPLAY MODULE AND MANUFACTURING METHOD FOR THE SAME

(71) Applicant: Wuhan China Star Optoelectronics Semiconductor Display Technology Co., Ltd., Wuhan (CN)

(72) Inventors: Wei BI, Shenzhen (CN); Shuru LIN, Shenzhen (CN)

(21) Appl. No.: 16/001,718

(22) Filed: Jun. 6, 2018

Related U.S. Application Data
(63) Continuation of application No. PCT/CN2018/075988, filed on Feb. 9, 2018.

(30) Foreign Application Priority Data
Nov. 10, 2017 (CN) 201711105250.1

(51) Int. Cl. B32B 38/18; B32B 7/12; B32B 37/12

(52) U.S. Cl. CPC B32B 38/1808; B32B 7/12; G09F 9/301; B32B 2590/00; B32B 37/12

(57) ABSTRACT

A flexible display module is disclosed. The flexible display module includes a flexible carrier plate and a flexible display panel including a folding region and a peripheral region disposed at two opposite sides of the folding region, wherein the flexible display panel is stacked on the flexible carrier plate. Wherein flexible carrier plate includes a first portion overlapped with the folding region and a second portion overlapped with the peripheral region, and wherein the first portion has a preset tension stress for coping with the folding region of the flexible display panel when the flexible display module is bent. The present invention can solve the uneven thickness of the adhesive material in the bending process of the flexible display panel.

### CROSS REFERENCE

This application is a continuing application of PCT Patent Application No. PCT/CN2018/075988, entitled “FLEXIBLE DISPLAY MODULE AND MANUFACTURING METHOD FOR THE SAME”, filed on Feb. 9, 2018, which claims priority to China Patent Application No. CN 201711105250.1 filed on Nov. 10, 2017, both of which are hereby incorporated in its entireties by reference.

### FIELD OF THE INVENTION

The present invention relates to a display technology field, and more particularly to a flexible display module and manufacturing method for the same.

### BACKGROUND OF THE INVENTION

Because a flexible display panel has features of thin, unbreakable flexible and wearable so that flexible display panel has been more and more attended. In a bending and flattening process of the flexible display panel, because an adhesive material disposed in the flexible display panel has a hysteresis phenomenon such that in the bending process of the display panel, the thickness of the adhesive material is uneven so that a waviness phenomenon is generated on a surface of the flexible display panel so as to affect a visual experience of an user.

### SUMMARY OF THE INVENTION

The purpose of the present invention is to provide a flexible display module and a manufacturing method for the same in order to solve the waviness phenomenon generated on a surface of the flexible display panel because of the uneven thickness of the adhesive material in the bending process of the flexible display panel.

The present invention provides a flexible display module, comprising: a flexible carrier plate; and a flexible display panel including a folding region and a peripheral region disposed at two opposite sides of the folding region, wherein the flexible display panel is stacked on the flexible carrier plate; wherein flexible carrier plate includes a first portion overlapped with the folding region and a second portion overlapped with the peripheral region; and wherein the first portion has a preset tension stress for coping with the folding region of the flexible display panel when the flexible display module is bent.

Wherein an included angle between a tangent line of a bending vertex of the first portion and a tangent line of an end point of the second portion is in a range of 0-20 degrees.

Wherein the first portion of the flexible carrier plate has a first preset tension stress of a first bending direction and a second preset tension stress of a second bending direction, and the first bending direction and the second bending direction are opposite.

Wherein a material of the flexible carrier plate is a metal, an amorphous metal or an organic compound.

Wherein a forming method of the flexible carrier plate includes a mold forming and a hot-bending forming.

Wherein the flexible carrier plate has a bending resistance, and can bear a bending amount to be greater than 200000.

Wherein a base layer is stacked on the flexible display panel, and a flexible cover is disposed on the base layer; the flexible display panel and the base layer are bonded through a first adhesive layer, the flexible cover and the base layer are connected through a second adhesive layer.

Wherein the base layer includes a circular polarizer and a sensor.

The present invention also provides a manufacturing method for a flexible display module, comprising: pre-bending a flexible carrier plate; flattening the flexible carrier plate; stacking a flexible display panel on the flexible carrier plate; and sequentially stacking a base layer and a flexible cover on the flexible display panel.

Wherein the step of pre-bending a flexible carrier plate includes a step of bending the flexible carrier plate in advance and fixing the flexible carrier plate in a carrier.

In summary, the flexible display panel of the flexible display module of the present invention is stacked on the flexible carrier plate. The first portion of the flexible carrier plate has a preset tension stress. When bending the flexible display module, the preset tension stress copes with the flexible display panel is bent in order to eliminate an uneven thickness of the adhesive material and slow down the waviness of the flexible display panel.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the person of ordinary skill in the art without creative effort, it can also obtain other figures according to these figures.

FIG. 1 is a schematic diagram of a flexible display module at a side view direction according to an embodiment of the present invention;

FIG. 2 is a schematic diagram of a flexible display panel shown in FIG

FIG. 3 is a schematic diagram of a flexible carrier plate shown in FIG. 1 in a pre-bending state;

FIG. 4 is a schematic diagram of a flexible display module in a bending state according to an embodiment of the present invention;

FIG. 5 is another schematic diagram of a flexible carrier plate shown in FIG. 1 in a pre-bending state;

FIG. 6 is a schematic diagram of a flexible display module in a bending state of another direction according to an embodiment of the present invention; and

FIG. 7 is a flow chart of a manufacturing method for a flexible display module according to an embodiment of the present invention.

### DETAILED DESCRIPTION OF THE PREFERRED EMBODIMENT

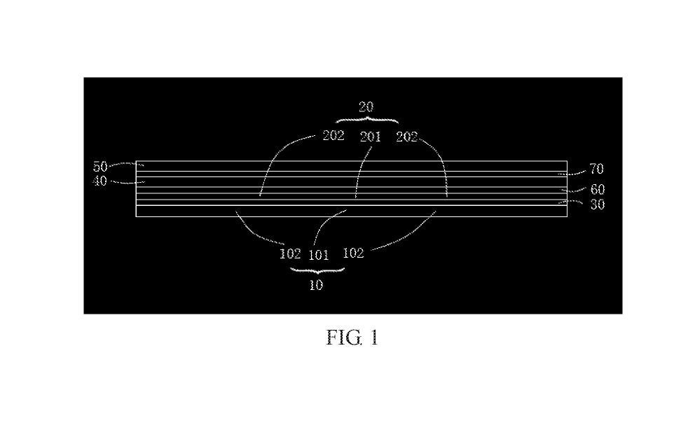

With reference to FIG. 1, the present invention provides a flexible display module, including a flexible carrier plate 10 and a flexible display panel 20. The flexible display panel 20 includes a folding region 201 and a peripheral region 202 disposed at two opposite sides of the folding region 201. The flexible display panel 20 is stacked on a surface of the flexible carrier plate 10. The flexible carrier plate 10 includes a first portion 101 overlapped with the folding region 101 and a second portion 102 overlapped with the peripheral region 202. The first portion 101 has a preset tension stress for coping with the folding region 201 of the flexible display panel 20 when the flexible display module is bent. In the present embodiment, the flexible carrier plate 10 is adhered to the flexible display panel 20 through a double-side adhesive 30. A material of the flexible carrier plate 10 is a metal, an amorphous metal or an organic compound. A forming method of the flexible carrier plate 10 includes a mold forming and a hot-bending forming. The flexible carrier plate 10 has a bending resistance, and can bear a bending amount to be greater than 200000.

With reference to FIG. 2, in the present embodiment, the flexible display panel 20 includes a first layer 201 and a second layer 202 disposed on the first layer 201. The first layer 201 and the second layer 202 are bonded through an adhesive material 203. The first portion 101 of the flexible carrier plate 10 is bent in advance before adhering to the flexible display panel 20. The first portion 101 of the flexible carrier plate 10 generates a preset tension stress in a process from a pre-bending state to a flattened state. The preset tension stress copes with the hysteresis of the adhesive material 203 when the flexible display panel 20 is bent in order to slow down the waviness of the flexible display panel 20. When the flexible carrier plate 10 is under the pre-bending status, an included angle between a tangent line of a bending vertex of the first portion 101 and a tangent line of an end point of the second portion 102 is in a range of 0-20 degrees. Wherein, the bending vertex is a vertex that the flexible carrier plate 10 is bent to form a curve. The first portion 101 of the flexible carrier plate 10 has a first preset tension stress of a first bending direction and a second preset tension stress of a second bending direction. The first bending direction and the second bending direction are opposite.

With reference to FIG. 1, a base layer 40 is stacked on the flexible display panel 20, and a flexible cover 50 is disposed on the base layer 40. The flexible display panel 20 and the base layer 40 are bonded through a first adhesive layer 60. The flexible cover 50 and the base layer 40 are connected through a second adhesive layer 70. The base layer 40 includes a circular polarizer 401 and a sensor 402. The sensor 402 is disposed on the circular polarizer 401. The sensor 402 is used for detecting an environment light. The circular polarizer 401 is used for resisting the environment light and reduces the interference of the environment light to the display. The flexible cover 50 is a resin cover for protecting the flexible display panel 20.

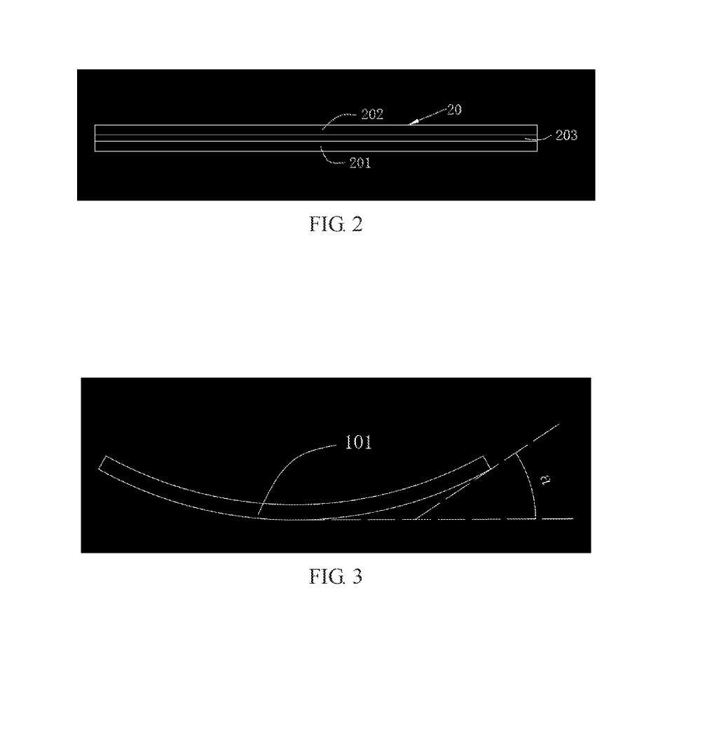

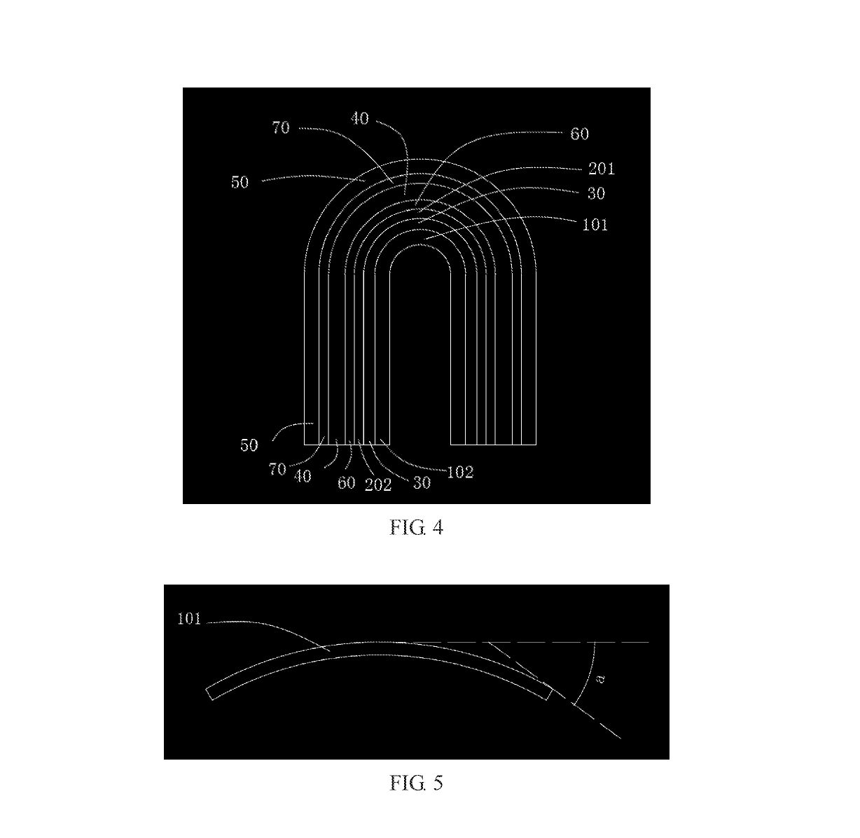

With reference to FIG. 3 and FIG. 4, the flexible display device can be bent or be bent at a specific region. When the flexible display module is bent by the first bending direction, the two second portions 102 are opposite. Because before the flexible carrier plate 10 is adhered to the flexible display panel 20, a preset bending direction of the first portion 101 of the flexible carrier plate 10 is opposite to the first bending direction, as shown in FIG. 3, when the first portion 101 is from a pre-bending state to a flattened state, a preset tension stress same as the first bending direction is generated. After the first portion 101 of the flexible carrier plate 10 is adhered to the flexible display panel 20, and the flexible display module is bent to the first bending direction, the preset tension stress same as the first bending direction generated by the first portion 101 copes with the hysteresis of the adhesive material 203 of the flexible display panel 20 in order to eliminate an uneven thickness of the adhesive material 203 and slow down the waviness of the flexible display panel 20. The flexible display module can be folded such that an included angle of the two second portions 102 ranges from 0 degree to 180 degree. The first bending direction is a direction that is from the flexible carrier plate 10 to the flexible cover 40.

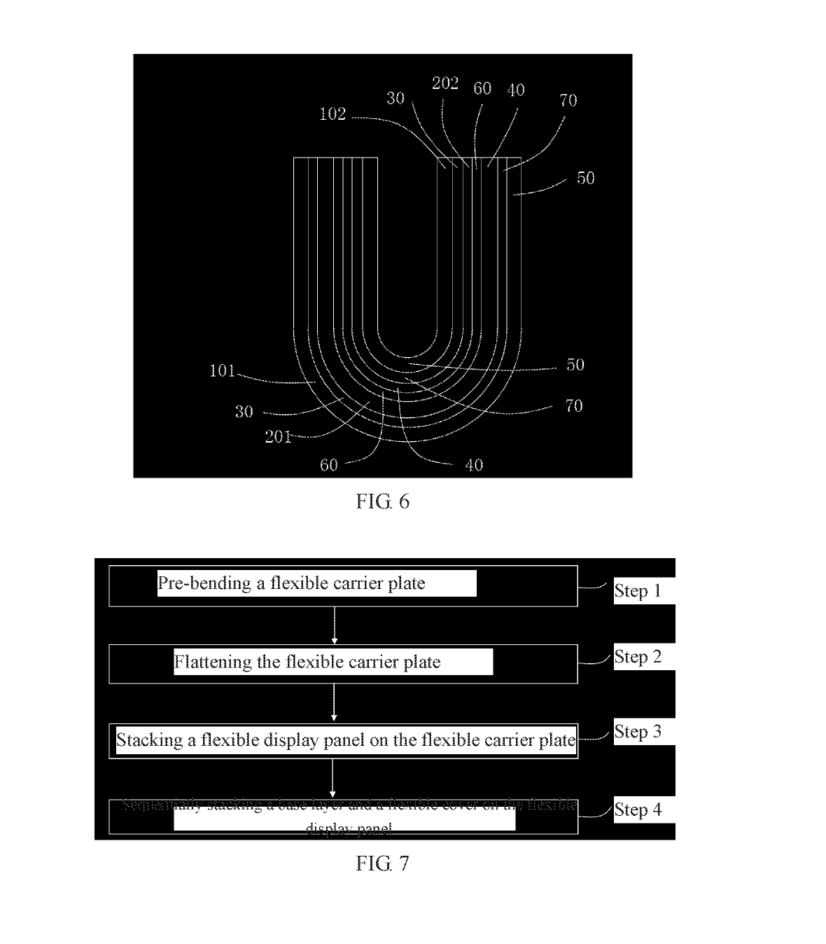

With reference to FIG. 5 and FIG. 6, when the flexible display module is bent by the second bending direction, the flexible covers are opposite. Because before the flexible carrier plate 10 is adhered to the flexible display panel 20, a preset bending direction of the first portion 101 of the flexible carrier plate 10 is opposite to the second bending direction, as shown in FIG. 4, when the first portion 101 is from a pre-bending state to a flattened state, a preset tension stress same as the second bending direction is generated. After the first portion 101 of the flexible carrier plate 10 is adhered to the flexible display panel 20, and the flexible display module is bent to the second bending direction, the preset tension stress same as the second bending direction generated by the first portion 101 copes with the hysteresis of the adhesive material 203 of the flexible display panel 20 in order to eliminate an uneven thickness of the adhesive material 203 and slow down the waviness of the flexible display panel 20. The flexible display module can be folded such that an included angle of the two second portions 102 ranges from 0 degree to 180 degree. The second bending direction is a direction that is from the flexible cover 40 to the flexible carrier plate 10.

With reference to FIG. 7, the present invention provides a manufacturing method for a flexible display module, and the method includes steps of:

Step 1: pre-bending a flexible carrier plate 10. Specifically, a flexible carrier plate is bent in advance, the flexible carrier plate 10 is bent to form a curve and being fixed in a carrier; an included angle between a tangent line of a bending vertex of the first portion 101 of the flexible carrier plate 10 and a tangent line of an end point of the second portion 102 of the flexible carrier plate 10 is in a range of 0-20 degrees. Wherein, the bending vertex is a vertex that the flexible carrier plate 10 is bent to form the curve.

Step 2: flattening the flexible carrier plate 10. Specifically, when the flexible carrier plate 10 is from a pre-bending state to a flattened state, the flexible carrier plate 10 generates a preset tension stress. The preset tension stress can be a preset tension stress of the first bending direction or a preset tension stress of the second bending direction, the first bending direction and the second bending direction are opposite.

Step 3: stacking a flexible display panel 20 on the flexible carrier plate 10. Specifically, through a double-side adhesive 30 to stack the flexible display panel 20 on the flexible carrier plate 10

Step 4: sequentially stacking a base layer 40 and a flexible cover 50 on the flexible display panel 20. Specifically, through a first adhesive 60 to stack the base layer 40 on the flexible display panel 20, and through a second adhesive layer 70 to stack the flexible cover 50 on the base layer 40.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A flexible display module, comprising:
a flexible carrier plate; and
a flexible display panel including a folding region and a peripheral region disposed at two opposite sides of the folding region, wherein the flexible display panel is stacked on the flexible carrier plate;
wherein flexible carrier plate includes a first portion overlapped with the folding region and a second portion overlapped with the peripheral region; and
wherein the first portion has a preset tension stress for coping with the folding region of the flexible display panel when the flexible display module is bent.

2. The flexible display module according to claim 1, wherein an included angle between a tangent line of a bending vertex of the first portion and a tangent line of an end point of the second portion is in a range of 0-20 degrees.

3. The flexible display module according to claim 1, wherein the first portion of the flexible carrier plate has a first preset tension stress of a first bending direction and a second preset tension stress of a second bending direction, and the first bending direction and the second bending direction are opposite.

4. The flexible display module according to claim 1, wherein a material of the flexible carrier plate is a metal, an amorphous metal or an organic compound.

5. The flexible display module according to claim 1, wherein a forming method of the flexible carrier plate includes a mold forming and a hot-bending forming.

6. The flexible display module according to claim 1, wherein the flexible carrier plate has a bending resistance, and can bear a bending amount to be greater than 200000.

7. The flexible display module according to claim 1, wherein a base layer is stacked on the flexible display panel, and a flexible cover is disposed on the base layer; the flexible display panel and the base layer are bonded through a first adhesive layer, the flexible cover and the base layer are connected through a second adhesive layer.

8. The flexible display module according to claim 7, wherein the base layer includes a circular polarizer and a sensor.

9. A manufacturing method for a flexible display module, comprising:
pre-bending a flexible carrier plate;
flattening the flexible carrier plate;
stacking a flexible display panel on the flexible carrier plate; and
sequentially stacking a base layer and a flexible cover on the flexible display panel.

10. The manufacturing method for a flexible display module according to claim 9, wherein the step of pre-bending a flexible carrier plate includes a step of bending the flexible carrier plate in advance and fixing the flexible carrier plate in a carrier.
